(19) United States
(12) Patent Application Publication
(10) Pub. No.: US 2024/0385317 A1
(43) Pub. Date: Nov. 21, 2024

(54) PERSON OR OBJECT DETECTION

(71) Applicant: Elliptic Laboratories ASA, Oslo (NO)

(72) Inventor: Espen KLOVNING, Strømmen (NO)

(73) Assignee: Elliptic Laboratories ASA, Oslo (NO)

(21) Appl. No.: 18/692,463

(22) PCT Filed: Nov. 3, 2022
(86) PCT No.: PCT/EP2022/080696

§ 371 Date: Mar. 15, 2024

(30) Foreign Application Priority Data
Nov. 5, 2021 (NO) 20211333

(51) Int. Cl. G01S 15/04

(52) U.S. Cl. CPC G01S 15/04

(57) ABSTRACT

The present invention relates to an electronic device configured for detecting an object, for example a person in the vicinity of the device. The device includes at least one audio signal generator, the generated signals being transmitted through an output interface to a speaker transmitting said mixed signal. The device also including at least one microphone configured to receive signals reflected from said object, and a receiver module for receiving said signals from the microphone, the receiver module also being connected to the output interface for receiving a signal there from corresponding to the signal transmitted through the speaker.

The present invention relates to person or object detection using electronic devices using acoustic signals.

Ultrasound is used by electronic devices for numerous different purposes including proximity detection, presence detection, gestures, etc, as discussed in WO2021/045628. All these use-cases rely on an electronic device both transmitting an ultrasound probe signal using at least one ultrasound transmitter (i.e. speaker, ultrasound transducer, ear-piece receiver, piezo-element) and processing the corresponding ultrasound echos received through at least one ultrasound receiver (i.e. microphone, ultrasound sensor, ultrasound transducer). Ultrasound signals are either narrowband (e.g sines, frequency-stepped sines), broadband (e.g. chirps, arbitrary modulation) or a combination of both. These signal types are typically used in different use-cases based on their specific characteristics.

Also as discussed in abovementioned WO2021/045628 some electronic devices are, while transmitting ultrasound, capable of running other audio use-cases for example audio playback using audio output components such as ear-piece receivers and speakers. These electronic devices will need to use DACs and audio amplifiers to play out the mixed signal of audio and ultrasound from the audio and ultrasound use-cases respectively. Some of them include simple amplifiers while others use Smart power amplifiers (Smart PA) such as described in WO2019/122864 (elliptic smart PA) which also has implemented an on-device audio digital signal processor (DSP) to perform necessary processing to control and protect the speaker. In some cases, Speaker Protection algorithms are implemented on the audio DSP in the System-On-Chip (SoC). The main purpose of a Speaker Protection algorithm is to monitor the speaker and rely on measurements related to temperature and excursion algorithms etc to protect the speaker while potentially playing as loud as possible. These protection algorithms may dynamically change the amplitude of the output signal to protect the speaker while at the same time playing sound at maximum amplitude given the current situation. The way the speaker protection modules work will create distortion and often harmonics in the output signal based on the characteristics of the speaker in use. Just like speaker protection algorithms will create models of the speaker behavior to enable the protection algorithm to protect the speaker while playing loud audio, the presence detection method described here could create models of the distortion and the harmonics based on the speaker output signal. These modules could be part of a ML training process where a large set of output snippets from a large sound library (e.g. Spotify, Apple Music, podcasts etc) and video library (e.g. YouTube) could be used as output data. These models could be used to select a preferred frequency range to utilize for the presence detection for a particular combination of speaker protection algorithm and a corresponding speaker model. The scheme outlined here could be used for speakers prone to destructive intermodulation when playing loud audio even before the speaker protection mechanism kicks in or in systems where the speaker is not protected by a speaker protection algorithm.

Usually, audio systems regardless of whether Speaker Protection algorithms are used or not will provide the echo cancellation module with an echo reference signal which is basically the signal sent out to the speaker. The echo reference signal is the actual, mixed output signal after the amplitude has potentially been altered by Speaker Protection algorithms. In this context, it is assumed that the echo reference signal can be routed to the Ultrasound receive processing module too enabling it to analyze among other things what the Speaker Protection algorithms have done to the ultrasound probe signal. Since echo cancellation is an important feature in systems using Smart PAs (e.g. smartphones and laptop etc.) the echo reference signal is usually even available not only from Speaker Protection modules running on the Audio DSP in the SoC but from externally connected Smart PAs using an audio interface (e.g. I2S, Soundwire, TDM etc).

In some Smart PAs, the audio and ultrasound signals will be kept apart and mixed immediately before being modulated out on the speaker. This is only viable if the ultrasound signal is part of the tuning process of the Speaker Protection algorithm and will not subject to any change due to excursion issues during use. In general, the ultrasound frequencies are too high to contribute to excursion issues that the Speaker Protection algorithm is meant to handle. Temperature changes are not as dynamic and are easier to deal with for the ultrasound processing given that the Speaker Protection will have time to provide control messages indicating that the ultrasound signal needs to change if necessary. In these Smart PAs, e.g. as described in abovementioned WO2019/122864, the ultrasound signal will in general not be modified by the Speaker Protection algorithm. The main reason they are kept apart is usually to reduce processing and memory usage when the sampling rate of the ultrasound signal is above the standard sampling rate for audio playback. Running Speaker Protection at a higher sampling rate is usually more expensive in terms of processing and memory requirements. Even if the ultrasound signal is kept apart from the concurrent use-cases, the ultrasound processing would benefit from receiving both the echo reference signal and the separate ultrasound signal in its processing.

It is thus an object of the present invention to provide a solution to improve presence detection based on an emitted acoustic signal where the transmitted acoustic signals may have been subject to changes due to willed adjustments or limitations in the signal processing prior to the signal emission. This is provided as stated in the accompanying claims.

Specifically, in ultrasound transmitting devices that support concurrent audio use-cases, the combined, mixed signal (i.e. audio mixed with ultrasound) will be played out using the speaker at the end of the audio output path. If any software or hardware component located after the ultrasound transmit module changes the ultrasound signal (e.g. amplitude, phase etc), the transmitted ultrasound signal is not what the ultrasound receive processing module expects.

Changing the ultrasound probe signal without letting the ultrasound receive processing module know about possible changes may affect the performance of the ultrasound solution. Ideally, any software or hardware module should send a message using whatever messaging mechanism (e.g. IPC, shared memory, etc) the audio framework in the device offers to the ultrasound receive processing module informing the ultrasound receive processing module about any changes done to the ultrasound probe signal before it is being played out. Ideally, the message will include an overview of all the possible operations by the Speaker Protection algorithms or other signal altering software or hardware modules have done on the ultrasound input or output signal. For example, if the system changes any gain settings on either the transmit or receive path, the ultrasound receive processing should be told via a control message. An alternative solution is to loopback the combined output signal back into the ultrasound receive processing module after all software or hardware modules have made the necessary changes to the signal but immediately before it is modulated by the speaker at the end of the output path. The echo reference signal discussed earlier is an example of such as signal. However, other components may route a similar output signal immediately before it is modulated by the speaker into at least one of the ultrasound processing modules. These modules, that is, the input and output processing modules may be realized as a single component or may be split in two separate communicating modules.

The present invention will be described more in detail below with reference to the accompanying drawings, illustrating the invention by way of examples.

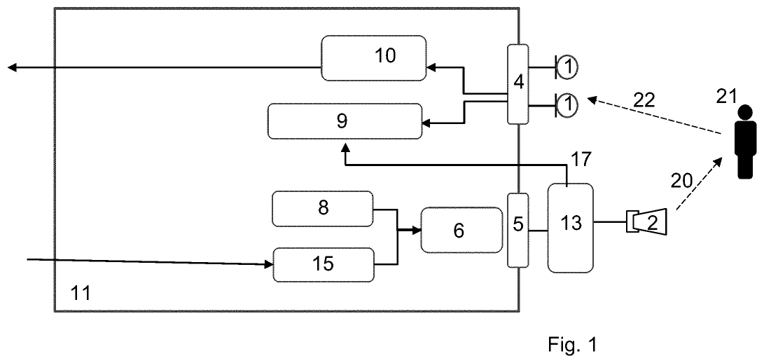

FIG. 1 illustrates a first embodiment including software mixing of ultrasound and audio signals and a smart-PA unit feeding the mixed output signal to the speaker and ultrasound receiver module.

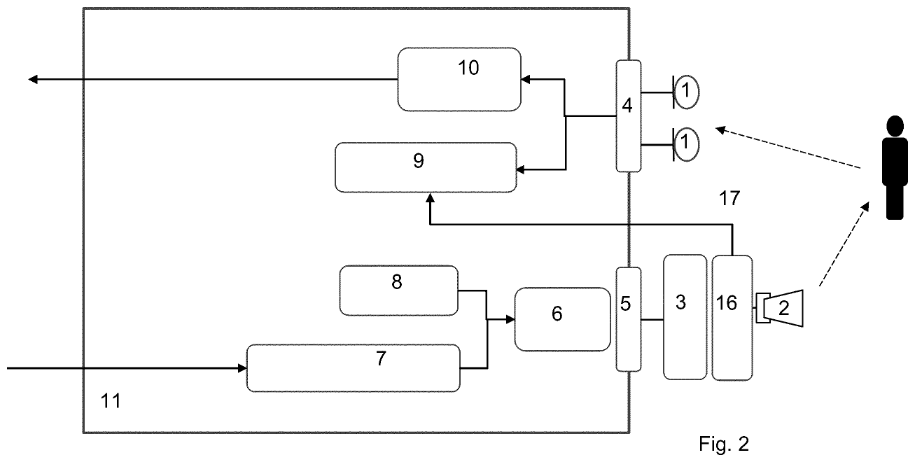

FIGS. 2-7 illustrates different alternative embodiments of the invention.

Referring to the drawings the following reference numerals have been used:

| | |
|---|---|
| 1. | Microphones |
| 2. | Speaker |
| 3. | Codec |
| 4. | Microphone Interface |
| 5. | Codec Interface |
| 6. | Module: Software Mixer |
| 7. | Module: Speaker Protection |
| 8. | Module: Ultrasound Signal Generator |
| 9. | Module: Ultrasound Receive Processing |
| 10. | Modules: Audio use-case |
| 11. | Digital Signal Processor |
| 12. | Hardware Mixer |
| 13. | Smart PA w/DSP |
| 14. | Amplifier |
| 15. | Gain Controller |
| 16. | Smart PA |
| 17. | Echo Reference |
| 18. | Mixer (Hardware or software) |

In FIG. 1 a first embodiment of the invention is illustrated where the device 11 includes an audio signal transmitter 15 configured to transmit signals in the audio range and an ultrasound signal transmitter 8 configured to transmit a signal in the ultrasound range. The audio transmitter 15 may receive signals from an external source. The signals from the transmitters 8, 15 are transmitted through a software mixer 6 combining the signals and transmitting the combined signal through a codec interface 5 to and in this example through a smart PA 13 with DSP, or similar generating a combined signal adapted to protect the speaker, to a speaker 2. The ultrasound signal 20 is chosen to be within the range of the speaker capacity but outside the hearing range, thus possibly in the range above 20 KHz.

At least one microphone 1 is configured to receive acoustic signals 22 at least within parts of the range of the transmitted signal and transmitting them through an interface 4 to a receiver processing module 9. Preferably the microphone 1, input interface 4 and receiver processing module 9 is at least configured to receive signals within the transmitted ultrasound range and for processing this signal for proximity detection.

The device illustrated in the drawings also includes a module for audio reception 10, which may be related to the ordinary use of the microphone in the device, e.g. in a mobile phone The audio reception device may in some cases also be connected to an echo reference (not shown) for using an audible signal for proximity detection, although at a lower resolution than the ultrasound signals.

According to the present invention the output transmitted to the speaker 2 is also transmitted as an echo reference signal 17 to the receiver 9. The receiver 9 is configured to compare the transmitted signal with the received signal. This comparison may be used to calculate the time shift between the transmitted signal 20 and the corresponding signals 22 received at the receiver providing an indication of a possible person or object 21 reflecting the transmitted signals. When monitoring an area, comparisons may be made to detect changes in the received signals indicating that a person has arrived in the proximity of the device. In addition, as the signal transmitted to the speaker will include any distortions or limitations in the transmitted signal, such as alterations caused by the speaker protection module, and they will be compensated for in the comparison.

The preferred embodiment of the present invention involves looping the echo reference signal 17 from the Speaker Protection module 13, 16 into the Ultrasound Receive Processing module 9. With this solution, the ultrasound receive processing 9 can use the loopback signal to find out what changes were done to the combined signal in all software and hardware modules after the signal was generated. This information can be used in the receive processing to improve the performance of the ultrasound sensor solution since these changes can be incorporated into the algorithms and possibly be used as machine learning features in the neural network that may be used in the ultrasound sensor solution. Relevant information are signal amplitude changes, possible filtering, signal tapering, phase changes, echos etc.

FIG. 2 illustrates a solution similar to the solution illustrated in FIG. 1, but where the signal from the output interface is transmitted through a codec 3 before being amplified by a smart PA 16, the signal from the smart PA being sent to the speakers as well as to the receiver processor 9. In addition, the input audio signal is received and adjusted by a speaker protection module 7 being positioned ahead of the mixer 6.

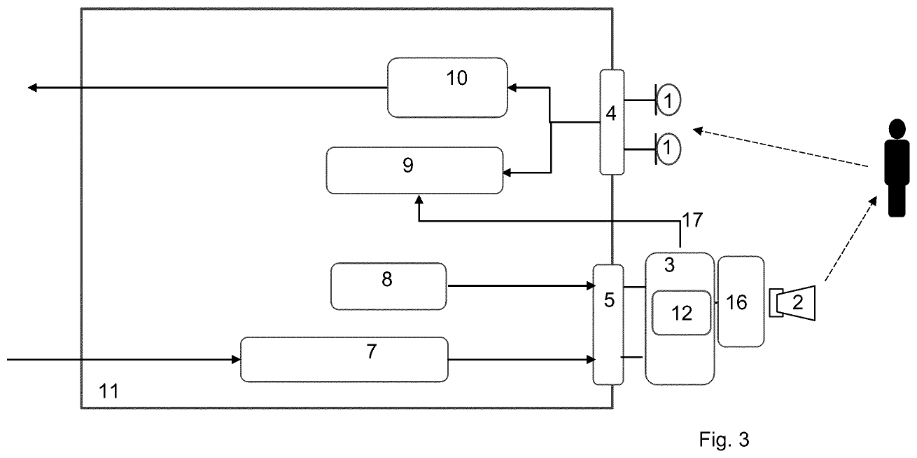

In FIG. 3 the input audio signal is adjusted by the speaker protection module 7 according to the known characteristics of the speaker 2. The audio and ultrasound signals from the protection module 7 and the ultrasound generator 8 are mixed in a codec 3 including a hardware mixer 12. The mixed signal being communicated to the ultrasound receiving processor and the smart power amplifier 16 transmitting the amplified signal to the speaker. In this case the echo reference will not contain any distortions added by the smart amplifier.

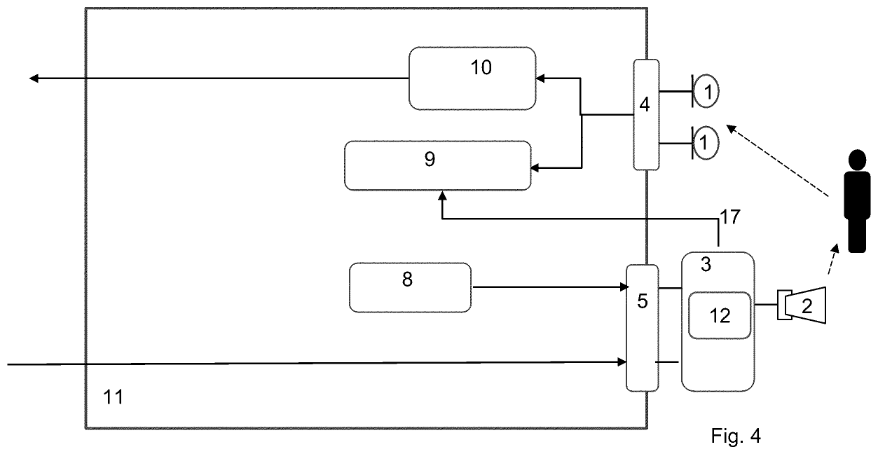

FIG. 4 illustrates an alternative to the input audio signal is transmitted directly through the codec interface 5 to the codec 3, the codec 3 including a hardware mixer 12. The codec transmitting an unamplified but mixed signal to the speaker 2.

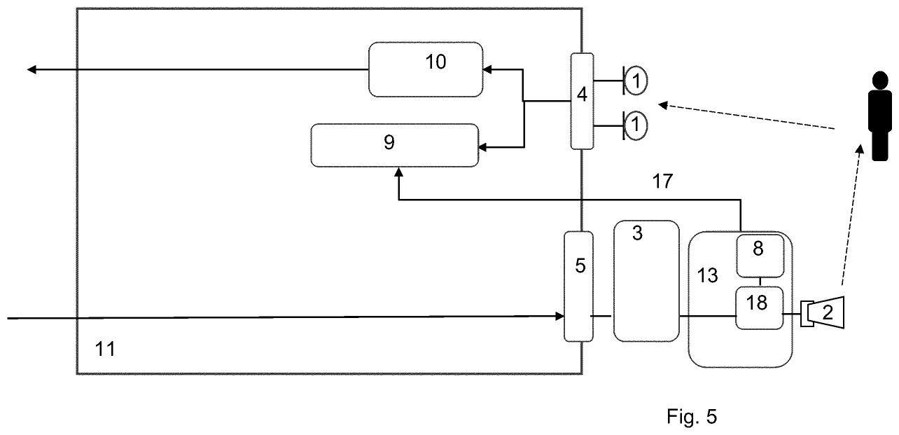

FIG. 5 illustrates an example where the input audio signal is transmitted directly through the codec interface 5 with the codec 3 outside the device, where the mixing is provided in an external smart PA including a DSP 13 as well as an ultrasound generator 8 and a hardware or software mixer 18 situated therein.

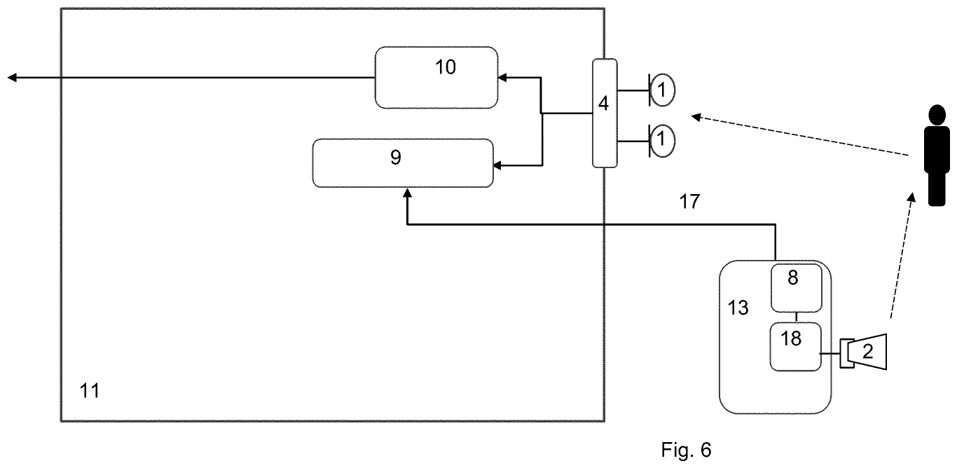

FIG. 6 illustrates the embodiment of FIG. 5 without any input audio signal. Thus, the proximity detection will be based on the ultrasound signal. As an alternative, the external smart PA in FIG. 6 may include an audio signal source such as a streamer connected to the mixer 18.

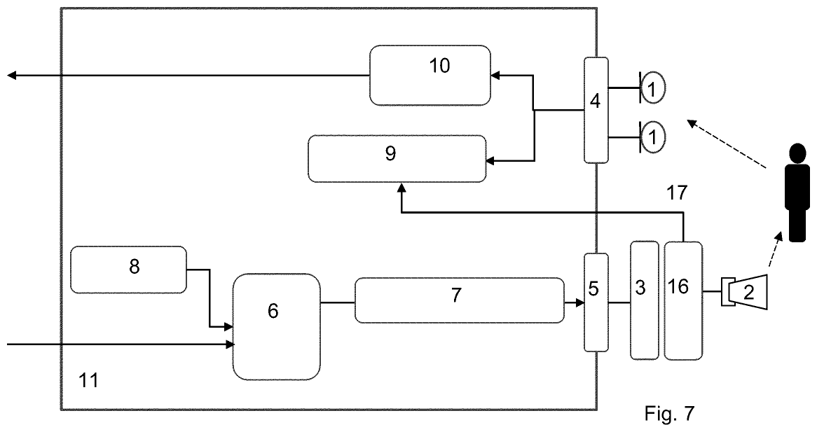

In FIG. 7 the input audio signal is mixed with the generated ultrasound signal 8 in software mixer 6 before being adjusted by a speaker protection module 7. The adjusted signal is then transmitted through the codec interface to the codec and further to a smart PA, transmitting the signal to the ultrasound receiver processor 9 and speaker 2.

In general, it should be noted that the present invention may include only one microphone 1, but if more than two microphones are available, they may be used by the receiver 9 to detect the direction of the reflected signals 22 as well as distinguish between more than one person or object in the vicinity of the device.

In systems without hardware mixers, mixing of concurrent audio and ultrasound signals has to be done in software in a processing element such as a DSP or a microcontroller. The loopback 17 of the combined signal will be done after the software mixing 11 is done as depicted in FIGS. 1 and 2. The software mixing 6 will either be done in a separate mixing module as illustrated in the figure. It is also possible to do the software mixing inside either the audio playback or ultrasound module. The former is illustrated in FIG. 7 that shows how the ultrasound signal can be fed into the Audio Playback path which will be responsible for the software mixing 6 before the combined signal is forwarded towards the speaker.

The combined signal in general or the ultrasound signal in particular may be modified by the mixing algorithm, the speaker protection algorithm in the Smart PA, or modified arbitrarily (e.g. gain changes) by a module after the mixing in the audio output path. The ultrasound signal is usually being generated either in the Smart PA or the ultrasound TX module itself. The ultrasound transmitting device will use the output signal to adjust the receive processing to match the actual ultrasound output signal both in amplitude and in time. The ultrasound TX may dynamically change the output rate (e.g. pulse rate) of the ultrasound probe signal as long as the ultrasound RX module is made aware of the change either by an explicit message or by extracting the altered timing of the ultrasound output signal from the loopback signal (e.g. echo reference signal).

With concurrently playing audio, if any, on the same output device sending a pulsed ultrasound signal, the ultrasound processing module could analyze the audio output signal and possibly even making the ultrasound signal generation temporarily delay its output signal to reduce probability of destructive intermodulation of the ultrasound output signal. The time-shift in ultrasound output signal needs to be handled by delaying the ultrasound receive processing similarly. This delay can either be detected or calculated by the processing module from the echo reference signal or the signal generation module may send some sort of message to inform about the time-shift.

In some audio architectures, the audio output stream may be available to the ultrasound modules before it is transmitted out on speaker. In this case, the ultrasound signal generator could temporarily reduce its own ultrasound output signal or change the type of ultrasound output signal to prevent or reduce probability of both distortions due to saturation of the output component and other invasive actions by the speaker protection algorithms to protect the speaker.

In systems where the audio data cannot be preprocessed in an audio buffer or similar, the alternative is to predict the audio output after mixing or changes made by speaker protection algorithms in Smart Power Amplifiers based on the audio signal that has already been modulated out on the speaker. It is possible to use machine learning to train a neural network to use parts if not all of the audio that has already been played out on the speaker to predict the future audio output to enable the ultrasound to be mixed into the audio output to reduce probability of saturation and more explicit actions taken by the speaker protection algorithms. This training could include feeding music from different genres found in a large audio libraries into a deep neural network (e.g. Apple Music, Spotify, YouTube). If the prediction fails and saturation happens, the ultrasound signal could be changed (e.g. reducing amplitude) or even delayed until a new successful prediction can be made. The prediction can be mixed with knowledge about other transmitting devices close by to handle both saturation, intermodulation and interference at the same time. Alternatively, the receive processing could use explicit information about the actual changes done by the Smart PA during it speaker protection algorithm. This information will require less data transfer and may be a smarter choice from a power consumption viewpoint.

It is also possible to make adjustments in the ultrasound processing if the output signal after the speaker protection (e.g. echo reference signal) is made available for post-processing in a software or hardware module capable of analyzing the final changes to the ultrasound probe signal and feed that information (e.g. amplitude variations, intermodulation levels, saturation, etc) into the receive processing done in the ultrasound receive module.

In high-end smartphones, mixing concurrent audio and ultrasound output streams is done in hardware mixers inside an audio codec as illustrated in the FIGS. 3 and 4 above. In these figures, the ultrasound input and output modules are two separate modules. These modules could of course be placed within a single software module.

Looping the Echo Reference signal back into the Ultrasound processing module allows this module to analyze the entire frequency band of the input signal. In situations where the electronic device is playing sound continuously or pulsed (e.g. alarm, video, music, gaming, video conference, etc), the Ultrasound processing module could use signals in the audible range as the probe signal instead of transmitting its own ultrasound output signal. As long as the sound is played and it is usable based on a set of criteria, the ultrasound detection can be done using the audible output. The ultrasound processing module should analyze the echo reference signal and possibly as a continuous process select identifiable components in the audible signal that are viable as the probe signal for the processing module to make the echo analysis or other types of echo signal analysis easier.

If the device stops playing sound, the ultrasound probe signal should be resumed. Once the sound playback resumes, the ultrasound probe signal can be paused again for a number of reasons (e.g. power consumption, intermodulation issues, interference handling, etc). Using the audio playback as a probe signal in an echo analysis, instead of a well-defined ultrasound signal, will require advanced processing which may include large neural networks. Based on the frequency components of an actual playback sound, the ultrasound processing modules may select signals from a specific frequency range as the basis from the randomized probe signal. The preferred frequency band may depend on the characteristics of the playback sound or the specific requirements or optimizations for the use-case in question.

It is well known that measurements based on ultrasound will increase the accuracy and resolution compared to audible frequencies. Thus, a detection system based on ultrasound utilizing a set of ultrasound transducers can be used to detect multiple objects close to the device. If an electronic device with at least one ultrasound output transducers sends out a broadband ultrasound signal (e.g. chirp, random modulation, frequency-stepped sines, etc), it can receive the ultrasound signal in at least one ultrasound input transducer and identify multiple objects in the targeted detection area. The different techniques to do this processing is known in the prior art as described in more detail in WO2017/137755, WO2009/122193, WO2009/115799 and WO2021/045628.

The resolution of the identified echos depends on bandwidth and frequency range of the signal. Higher sampling rates supported already by some consumer electronics (e.g. 96 KHz, 192 KHZ, 384 KHz, etc) allows an increased signal bandwidth (e.g. more than 10 KHz) in a frequency range above the audible frequency range. With an increased signal frequency range and signal bandwidth, it is possible to identify multiple users (e.g. objects) and for each of them separate the different body parts such as fingers, hands, arms, head, torso, legs, etc.

In one embodiment of this invention, a laptop could send out a high-frequency, broadband signal to detect user presence. It could also detect user posture and breathing pattern while the user is sitting in front of the laptop whether he/she is interacting with it or not. The echo information could be combined with sensor data (e.g. hinge angle sensor, IMU sensor, light sensor, pressure sensor, ambient light sensor, etc) to provide more accurate information related to the detection. Identifying users peeking over the shoulder of the main laptop user is also possible with the increased resolution described here.

In another embodiment, a presence detection device could send out a high-frequency broadband signal to detect user presence. Since the resolution of the echos will be significantly higher and more details can be extracted, the presence detection device could monitor user movement and fed the data into an incremental, on-device ML-training process to create a continuously updated system such as deep neural network (DNN) that can be used to detect anomalies in user movement and gait.

To summarize the present invention relates to an electronic device configured for detecting an object, for example a person in the vicinity of the device. The device including at least one audio signal generator, the generated signals being transmitted through an output interface to a speaker transmitting said mixed signal, where the signal may be in the audible and/or ultrasound range. The device also includes at least one microphone configured to receive signals reflected from said object, and also a receiver module for receiving said signals from the microphone, the receiver module also being connected to the output interface for receiving a signal there from corresponding to the signal transmitted through the speaker. The receiver processing module is thus configured to compare the transmitted signal with the received signal thus compensating for distortions in the transmitted signal, and to detect the object based on the two signals, e.g. by detecting the time lapse between the transmission and reception.

At least one signal generator may be configured to generate signal within the ultrasound range, the microphone being configured to received signals within the ultrasound range, the device preferably also including an audio generator generating a second signal in the audible range, the ultrasound and audio signals being mixed in a mixing module.

The device may also include a speaker protection module being configured to receive said signals from the ultrasound and audio generators and to adjust the signal transmitted to the speaker according to predetermined characteristics so as to avoid exceeding the specifications of the speaker.

The speaker protection module may be included in the mixing module or may be connected to the mixing module for receiving the mixed signal and adjusting it according to the speaker specifications.

The generated signal may constitute a known audio signal, such as a section of music, and the receiver module is configured to analyze the measured reflected signal based on a comparison between the transmitted and received signals.

The receiver module may be configured to compare the transmitted and received signal based on a prestored data set, where the prestored data set may be based on a set of previous measurements analyzed using a machine learning algorithm selecting characteristics in the received signal indicating the presence of a person.

The device based on the signals received by the receiver module may be used to detect whether a user is in the vicinity of the device by analysing the reflected signals compared to the transmitted signals. Based on the direct comparison it may also be capable of detecting movements, such as gestures, made by a user close to the device or the posture of the user both. This may be performed using more than one microphone and preferably the upper audible and ultrasound ranges the size of the user as well as the gestures. It is also differentiating between a passive object and a user by analyzing the movements in a sequence of measurements at a predetermined rate and by using high frequency signals to recognize turbulence and thus breathing close to the object. Using only the microphones it is also possible to use voice recognition to recognize a specific user, calculate the user position and thus ignore other users and objects in the area.

1-10. (canceled)

11. An electronic device configured for detecting an object in the vicinity of the electronic device, the electronic device comprising:
at least one audio signal generator, the generated signals being transmitted through an output interface including a speaker protection module to a speaker transmitting an acoustic signal, the speaker protection module being configured to add a distortion to the signal;
at least one microphone configured to receive signals reflected from the object; and
a receiver processing module for receiving the signals from the microphone, the receiver processing module also being connected to the output interface for receiving a signal therefrom corresponding to the signal transmitted through the speaker, the receiver processing module being configured to compare the transmitted signal with the received signal and compensating for distortions added to the generated signal by the speaker protection module in the transmitted signal, and to detect the object based on the compensated signals.

12. The device according to claim 11, wherein the at least one signal generator is configured to generate signal within the ultrasound range, the microphone being configured to received signals within the ultrasound range.

13. The device according to claim 12, wherein the ultrasound generator is a separate generator, the signal from the audio generator and the ultrasound generator being mixed in a mixing module.

14. The device according to claim 13, comprising a speaker protection module configured to receive the signals from the ultrasound generator and the audio generator and to adjust the signal transmitted to the speaker according to predetermined characteristics so as to avoid exceeding a specifications of the speaker.

15. The device according to claim 14, wherein the speaker protection module is included in the mixing module.

16. The device according to claim 14, wherein the speaker protection module is connected to the mixing module for receiving and adjusting the mixed signal according to speaker specifications.

17. The device according to claim 11, wherein the generated signal is within the audible range.

18. The device according to claim 17, wherein the generated signal constitutes a known audio signal and the receiver module is configured to analyze the measured reflected signal based on a comparison between the transmitted and received signals.

19. The device according to claim 11, wherein the receiver module is configured to compare the transmitted and received signal based on a prestored data set.

20. The device according to claim 19, wherein the prestored data set is based on a set of previous measurements analyzed using a machine learning algorithm selecting characteristics in the received signal indicating the presence of a person.
